(19) United States
(12) Patent Application Publication
(10) Pub. No.: US 2026/0310516 A1
(43) Pub. Date: Oct. 8, 2026

(54) PROCESSING UNIT OCCUPANCY RULES AND PRIORITIZATION RULES FOR ARTIFICIAL INTELLIGENCE ENABLED USE CASES

(71) Applicant: Apple Inc., Cupertino, CA (US)

(72) Inventors: Weidong Yang, San Diego, CA (US); Huaning Niu, San Jose, CA (US); Dawei Zhang, Saratoga, CA (US); Haitong Sun, Cupertino, CA (US); Wei Zeng, Saratoga, CA (US); Seyed Ali Akbar Fakoorian, San Diego, CA (US); Oghenekome Oteri, San Diego, CA (US); Chunxuan Ye, San Diego, CA (US)

(21) Appl. No.: 19/481,368

(22) PCT Filed: Apr. 10, 2024
(86) PCT No.: PCT/US2024/023893

§ 371 Date: Nov. 4, 2025

Related U.S. Application Data
(60) Provisional application No. 63/466,260, filed on May 13, 2023.

(51) Int. Cl. G06F 9/50; H04B 7/06

(52) U.S. Cl. CPC G06F 9/5044; H04B 7/0626; H04B 7/0695; G06F 2209/501; G06F 2209/5021

(57) ABSTRACT

A user equipment (UE) includes a transceiver and a processor. The processor is configured to transmit, via the transceiver, an indication of a number of simultaneous processing units available for artificial intelligence (AI) enabled computations of at least one type at the UE. The processor is also configured to deny or delay simultaneous AI enabled computations that exceed the number of simultaneous processing units available for AI enabled computations of the at least one type at the UE.

### CROSS-REFERENCE TO RELATED APPLICATION

This Patent Cooperation Treaty patent application claims priority to U.S. Provisional Patent Application No. 63/466,260, filed May 13, 2023, and titled “Processing Unit Occupancy Rules and Prioritization Rules for Artificial Intelligence Enabled Use Cases,” the contents of which are incorporated herein by reference in its entirety.

### TECHNICAL FIELD

This application relates generally to wireless communication systems, including systems in which a user equipment (UE) may use artificial intelligence (AI) to make channel state information (CSI) inferences, make beam predictions, or determine positioning information.

### BACKGROUND

Wireless mobile communication technology uses various standards and protocols to transmit data between a network device (e.g., a base station, a radio head, etc.) and a wireless communication device. Wireless communication system standards and protocols can include, for example, 3GPP long term evolution (LTE) (e.g., 4G), 3GPP NR (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a network device of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the network device and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A network device used by a RAN may correspond to that RAN. One example of an E-UTRAN network device is an Evolved Universal Terrestrial Radio Access Network (E-UTRAN) Node B (also commonly denoted as evolved Node B, enhanced Node B, eNodeB, or eNB). One example of an NG-RAN network device is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example application of channel state information (CSI) processing unit (CPU) occupancy rules to CSI computations.

FIG. 2 shows example processing time requirements for CSI computations.

FIG. 3 shows an example portion of a communications system, according to embodiments described herein.

FIGS. 4A-4D show examples of UE capability signaling in legacy designs, according to embodiments described herein.

FIG. 5 shows an example method of wireless communication by a UE, according to embodiments described herein.

FIGS. 6-8 and 10-12 show example configurations of processing units (or processing resources) for processing AI enabled computations and non-AI computations, according to embodiments described herein.

FIGS. 9A and 9B show new examples of UE capability signaling, according to embodiments described herein.

FIG. 13 shows an example method of wireless communication by a network device (e.g., a network device of a RAN), according to embodiments described herein.

FIG. 14 shows an example method of wireless communications by a network device (e.g., a network device of a CN), according to embodiments described herein.

FIG. 15 illustrates an example architecture of a wireless communication system, according to embodiments described herein.

FIG. 16 illustrates an example system for performing signaling between a wireless device and a network device, according to embodiments described herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with a network. Therefore, the UE as described herein is used to represent any appropriate electronic device.

CPU occupancy rules were initially agreed to for CSI feedback (in 3GPP Release 15 (Rel-15)). The CPU occupancy rules were then expanded to cover feedback for beam management. In 3GPP Rel-16, the CPU occupancy rules were further extended to cover L1-SINR feedback.

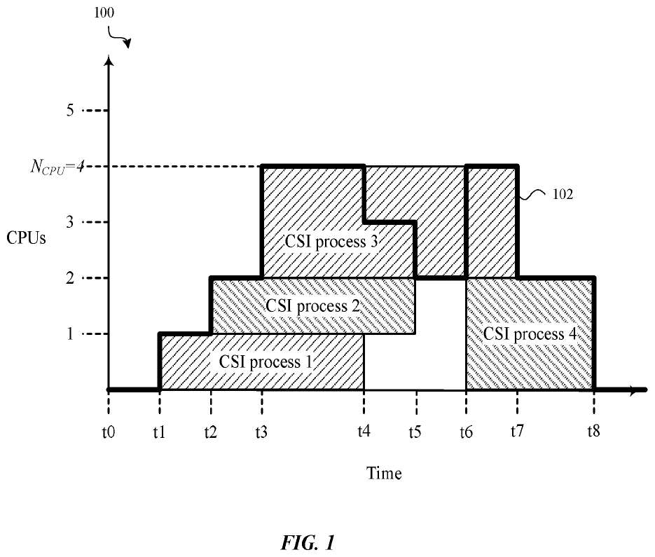

3GPP technical specification (TS) 38.214 V17.5.0 (2023-03), § 5.2.1.6, states, “The UE indicates the number of supported simultaneous CSI calculations N_{CPU} with parameter simultaneousCSI-ReportsPerCC in a component carrier (CC), and simultaneousCSI-ReportsAllCC across all component carriers. If a UE supports N_{CPU} simultaneous CSI calculations it is said to have N_{CPU} CSI processing units for processing CSI reports. If L CPUs are occupied for calculation of CSI reports in a given OFDM symbol, the UE has N_{CPU}-L unoccupied CPUs . . . . ” An application of this CPU occupancy rule is described with reference to FIG. 1.

FIG. 1 shows a graph of CPU use at a UE over time. At time t0, no CPUs are in use. N_{CPU} is assumed to be 4. At time t1, the UE begins calculations for a first CSI process (CSI process 1) occupying one CPU. This CPU remains occupied until time t4. At time t2, the UE begins calculations for a second CSI process (CSI process 2) occupying one CPU. This CPU remains occupied until time t5. At time t3, the UE begins calculations for a third CSI process (CSI process 3) occupying two CPUs. These CPUs remain occupied until time t7. At time t3, the UE has all of its CPUs in use (i.e., N_{CPU}=4) and the UE cannot handle any additional CSI processes. However, at time t4, the first CSI process completes and one of the UE's CPUs becomes available. At time t5, another CPU becomes available, such that, at time t6, the UE is able to begin calculations for a fourth CSI process (CSI process 4). At time t8, all of the UE's CPUs are once again available. Bold line 102 indicates the current number of CPUs that are in use at the UE.

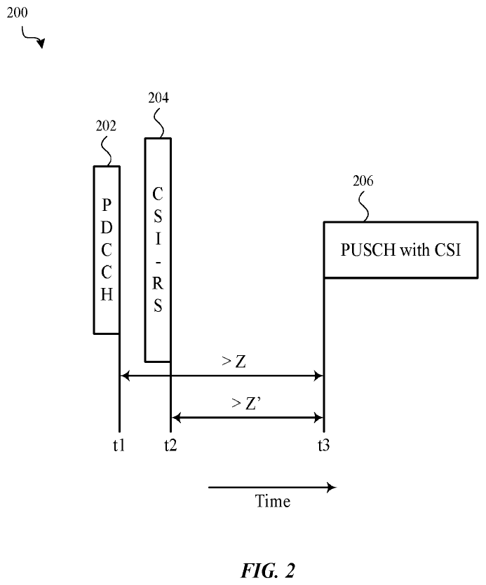

Before beginning calculations for a CSI process, as shown in FIG. 1, a UE may need to determine whether certain processing time requirements are met. A network (e.g., a network device of a RAN, such as a gNB) may also determine whether the processing time requirements, before triggering the UE to perform the CSI process. FIG. 2 shows an example of these processing time requirements for an aperiodic CSI report based on an aperiodic CSI reference signal (CSI-RS). Different processing time requirements may be provided for an aperiodic CSI report based on periodic CSI-RS, and for other reporting scenarios.

As shown in FIG. 2, a physical downlink control channel (PDCCH) 202 carrying downlink control information (DCI) that triggers a CSI report may be completely received by a UE at time t1. A CSI-RS 204 on which the CSI report is based may be completely receive by the UE at time t2. The UE may begin to transmit the CSI report on a physical uplink shared channel (PUSCH) 206 at time t3. Processing time requirements may be defined or configured to indicate the minimum times that need to be allowed, by a network device, for the UE to transmit the CSI report on the PUSCH 206. One of the processing time requirements may be designated Z, and may be a minimum amount of time between the UE's reception of the PDCCH 202 carrying the DCI that triggers the CSI report (at time t1) and the time the UE begins transmitting the PUSCH 206 that carries the CSI report (at time t3). Another processing time requirement may be designated Z′, and may be a minimum amount of time between the UE's reception of the CSI-RS 204 on which the CSI report is based (at time t2) and the time the UE begins transmitting the PUSCH 206 that carries the CSI report (at time t3). These and are other processing time requirements are also described in 3GPP TS 38.214 V17.5.0 (2023-03), § 5.2.1.6.

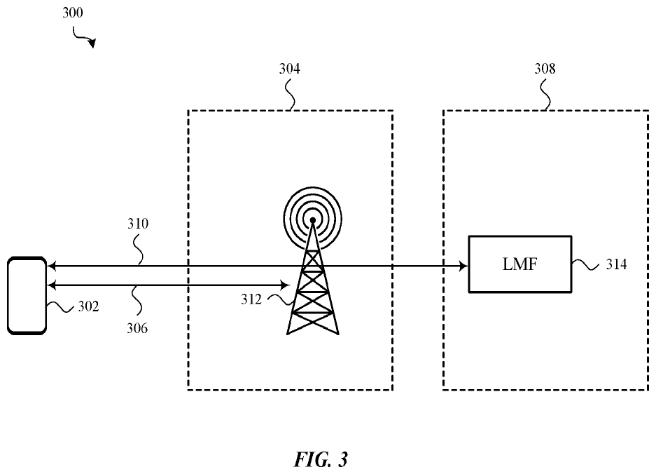

Although CPU occupancy rules and CSI processing time requirements are defined for non-AI CSI and beam management (BM) calculations, there are no equivalent type of occupancy rules or processing time requirements defined for AI enabled calculations (or computations, which are defined herein to include calculations). Nor are there any type of occupancy rules or processing time requirements defined for positioning computations. In regard to positioning computations, it is noted that positioning information is reported by a UE to a network device of a CN (e.g., a location management function (LMF)). This is in contrast to CSI and BM reports, which are reported to a network device of a RAN (e.g., a gNB). An example portion of a communications system including a UE, a RAN, and a CN is described with reference to FIG. 3.

As shown in FIG. 3, a UE 302 may communicate with a RAN 304 via an access stratum 306, and with a CN 308 via a non-access stratum 310. More particularly, the UE 302 may communicate with one or more network devices 312 (e.g., one or more gNBs) of the RAN 304, and with one or more network devices 314 (e.g., an LMF) of the CN.

CSI and BM reports may be configured and received by a network device 312 of the RAN, and positioning reports may be configured and received by a network device 314 of the CN.

Described herein are three use cases for AI: CSI feedback; beam management; and positioning. There are different ways that these use cases can be mapped to UE hardware. For example, a UE's baseband processor may be made powerful enough to process all three use cases, without introducing a dedicated (or separate) neural network engine. As another example, a UE could have a dedicated (or separate) neural network engine to handle AI model inferences on the UE side (e.g., the UE could use a legacy vector digital signal processing (DSP) engine for non-AI CSI/BM processing, and use a dedicated (or separate) neural network engine (i.e., an AI model) for AI enabled CSI/BM inferences). In this manner, non-AI CSI/BM processing does not compete with AI enabled processing for computational or storage (e.g., memory) resources. In these cases, it may not be necessary to modify current CPU occupancy rules and processing time requirements, and a separate set of occupancy rules may be established for AI enabled processing. As another example, an AI model for CSI processing may be very complex and an AI model for beam management may be much simpler. In these cases, AI enabled BM interferences might be made by a legacy vector DSP engine, but AI enabled CSI inferences may be made by a dedicated (or separate) neural network engine. In general, there are different ways to map the processing load to different one or more processing engines.

For purposes of this description, AI is defined as a computer-based technology that solves tasks that typically require human intelligence. Machine learning (ML) is defined as a subset of AI, and more particularly is defined as a computer-based technology that solves specific tasks by learning from data and making predictions. References in this description to AI are intended to also refer to ML (as a subset of AI).

During 3GPP Rel-15 discussions, it was agreed that the implementation complexity for CSI reporting may vary substantially with respect to report quantity and codebook configuration (e.g., 4 transmit (Tx) antennas vs 32 Tx antennas, or Type I codebook vs Type II codebook). A quite coarse quantization was adopted to define what is a single “CPU”, and the required number of “CPUs” to perform different tasks. For AI enabled computations, the AI model inference complexity for CSI reporting can vary with respect to the AI model. For example, in some cases, the CSI inference AI model may have a transformer as its backbone, and the computation complexity count may be in the millions of floating point operations (FLOPS). In other cases, a site/cell specific CSI inference AI model may consist of a few layers with a small number of neurons for each layer, which has a very different complexity than a transformer-based AI model. For beam management, many studies have found that a fully connected network with a few layers is sufficient for beam prediction. However, some UE vendors may prefer to use a transformer-based AI model for beam prediction. In general, however, AI enabled BM computations tend to be much less complex (simpler) than AI enabled CSI computations, with some exceptions. More generally, the complexity of AI models, and AI enabled computations, vary between use cases (e.g., between CSI, BM, and positioning), and the complexity of AI enabled computations can vary between AI models for the same use case.

For NR modem implementations, some vendors may deploy a separate engine (or model) for AI enabled computations (i.e., an engine that is separate from the vector DSP engine, hardware, or other computational engine(s) or device(s) used for non-AI CSI/BM computations). Currently, the processing of non-AI CSI/BM computations and non-AI positioning computations is already handled by different sets of resources, which different sets of resources can be supported by different computational engines or devices and/or by scheduling or partitioning computational, storage, and/or other resources that use the same hardware or engine(s) (e.g., the same hardware or engine(s) at different times, or different portions of the same hardware or engine(s), which different portions may be used simultaneously or contemporaneously). Such factors and considerations may need to be considered if the concept of CPU occupancy rules (or more generally, processing unit occupancy rules) and processing time restrictions are to be extended to AI enabled computations and/or to non-AI or AI enabled positioning computations. For positioning computations, it is noted that the processing of a positioning reference signal (PRS) is not currently subject to the CPU occupancy rules or processing time requirements defined by 3GPP TS 38.214 V17.5.0 (2023-03), § 5.2.1.6.

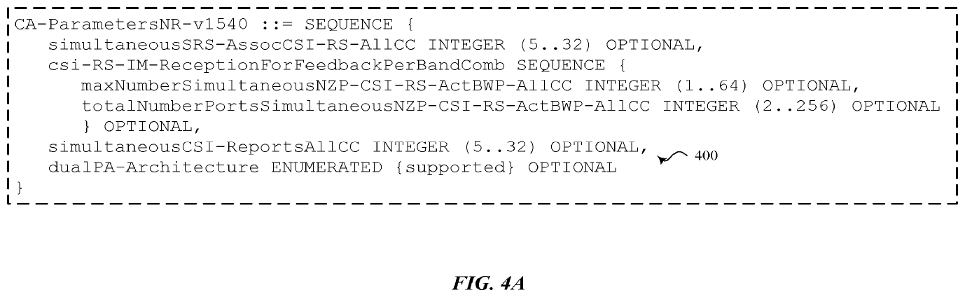

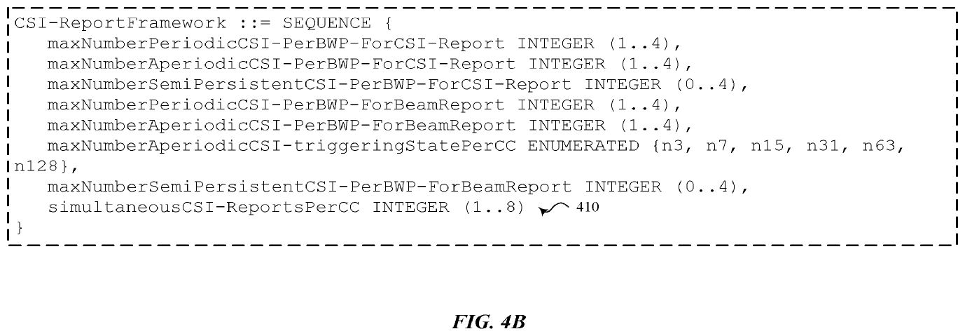

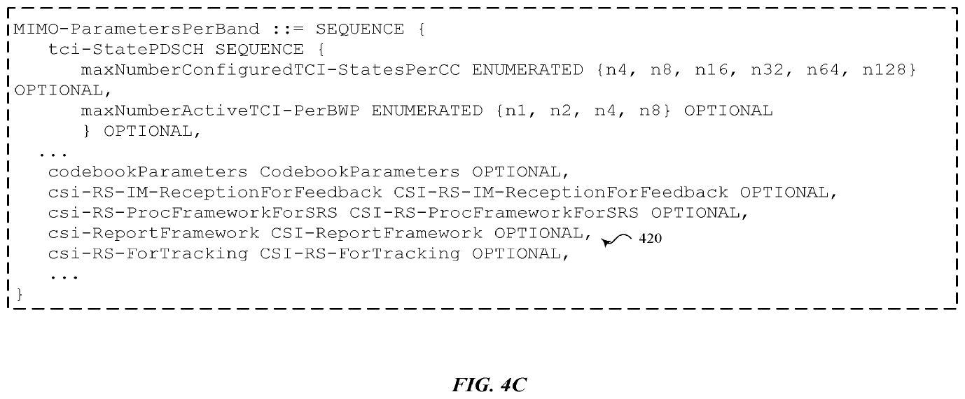

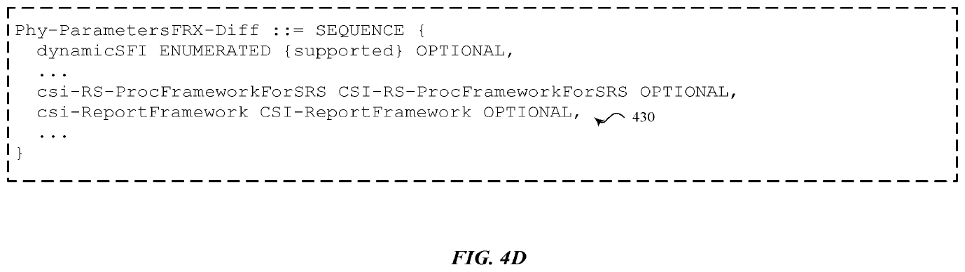

Some examples of UE capability signaling in legacy designs is shown in FIGS. 4A-4D. Two radio resource control (RRC) parameters—simultaneousCSI-ReportsAllCC (an information element (IE) 400 shown in FIG. 4A) and simultaneousCSI-ReportsPerCC (an IE 410 shown in FIG. 4B)—are of particular relevance to CPU occupancy rules. The IE simultaneousCSI-ReportsAllCC 400 is introduced in 3GPP TS 38.331, and as stated in 3GPP TS 38.306, simultaneousCSI-ReportsAllCC indicates whether a UE supports CSI report framework and indicates the number of CSI report(s) which the UE can simultaneously process across all CCs, and across MCG (Master Cell Group) and SCG (Secondary Cell Group) in case of NR dual connectivity (NR-DC). The CSI report includes periodic, semipersistent, and aperiodic CSI, and any latency classes and codebook types. The CSI report in simultaneousCSI-ReportsAllCC includes the beam report and CSI report. This parameter may further limit simultaneousCSI-ReportsPerCC in MIMOParametersPerBand and Phy-ParametersFRX-Diff for each band in a given band combination. The IE simultaneousCSI-ReportsPerCC 410 is also introduced in 3GPP TS 38.331. Its use for providing a limit for a band is described in 3GPP TS 38.331, as shown in FIG. 4C at 420; and its use for providing a limit for a band in a band combination is also described in 3GPP TS 38.331, as shown in FIG. 4D at 430. Hence, the maximum number of CPUs per CC and the maximum number of CPUs across CCs (including CCs over MCG and SCG) can be derived from UE capability signaling and a network's configuration of carrier aggregation and/or dual connectivity for a UE.

Given the above context, techniques for applying processing unit occupancy rules and/or processing time requirements are described herein.

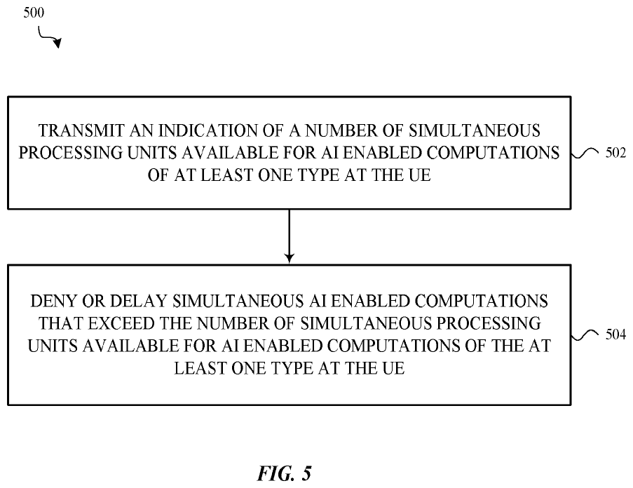

FIG. 5 shows an example method 500 of wireless communication by a UE. In some cases, the UE may be the UE described with reference to FIG. 1 or one of the other UEs described herein. The method 500 may be performed using a transceiver (or radio), a processor, or other components of the UE.

At 502, the method 500 may include transmitting, via the transceiver, an indication of a number of simultaneous processing units available for AI enabled computations of at least one type at the UE. The AI enabled computations of the at least one type may include, for example, AI enabled CSI computations, AI enabled BM computations, and/or AI enabled positioning computations. The indication may be transmitted, for example, to a network device of a RAN (e.g., to a gNB, via an access stratum) and/or to a network device of a CN (e.g., to an LMF, via a non-access stratum). In some embodiments, the indication may be transmitted to the network (e.g., the RAN or CN) in UE capability signaling and/or UE assistance information.

At 504, the method 500 may include denying or delaying simultaneous AI enabled computations that exceed the number of simultaneous processing units available for AI enabled computations of the at least one type at the UE. In one example of denying an AI enabled computation, an AI enabled computation that is needed to provide fresh content for a CSI report may not be performed (assuming that the AI computation would cause the UE to exceed the number of simultaneous processing units available for AI enabled computations of the at least one type at the UE), but the UE may still respond to the request for the CSI report by providing stale or obsolete content (i.e., content that does not require additional AI enabled computations) for the CSI report.

The method 500 may be variously embodied, extended, or adapted, as described in the following paragraphs and elsewhere in this description.

In some embodiments of the method 500, the number of simultaneous processing units available for AI enabled computations of the at least one type may be also available to at least one type of non-AI computation (i.e., the number of simultaneous processing units is shared between one or more types of AI enabled computations and one or more types of non-AI computations). In these embodiments, the method 500 may include denying or delaying AI enabled computations, non-AI computations, or a combination of AI enabled computations and non-AI computations that exceed the number of simultaneous processing units available for AI enabled computations of the at least one type at the UE.

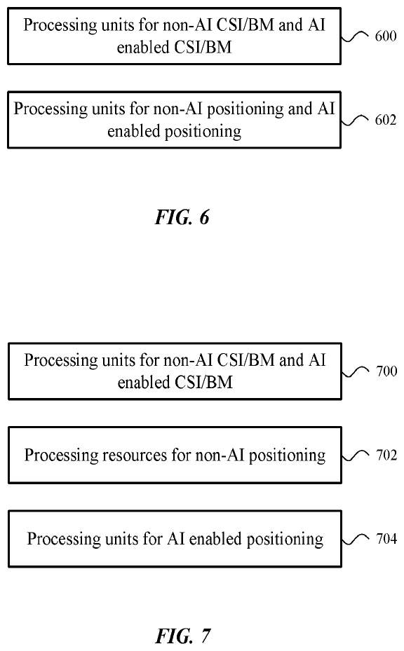

In some embodiments of the method 500, the indication of the number of simultaneous processing units available for AI enabled computations of the at least one type at the UE may be a first indication of a first number of simultaneous processing units available for AI enabled CSI computations, AI enabled BM computations, non-AI CSI computations, and non-AI BM computations at the UE, as shown in FIG. 6 at 600. In these embodiments, the method 500 may also include transmitting, via the transceiver, a second indication of a second number of simultaneous processing units available for AI enabled positioning computations and non-AI positioning computations at the UE, as shown in FIG. 6 at 602. In these embodiments, the processing units (and typically processing engine(s)) provided for CSI/BM computations are separated from the processing units (and typically processing engine(s)) provided for positioning computations. This may be useful, for example, in that UE capabilities for CSI/BM computations may need to be signaled to a network device of a RAN, and UE capabilities for positioning may need to be signaled to an LMF. In some embodiments, the number of simultaneous processing units available for AI enabled CSI computations, AI enabled BM computations, non-AI CSI computations, and non-AI BM computations may be managed as already described in technical specifications for managing CPUs available for non-AI CSI computations and non-AI BM computations (possibly with extensions to address AI aspects). In these embodiments, and if UE capability signaling is used for the indication, the signaling messages shown in FIGS. 4A-4D may be leveraged/reused. In some embodiments, the number of simultaneous processing units available for AI enabled positioning computations and non-AI positioning computations may be managed similarly to, but separately from, the number of CPUs available for non-AI CSI computations and non-AI BM computations (possibly with extensions to address positioning aspects).

In some embodiments of the method 500, the indication of the number of simultaneous processing units available for AI enabled computations of the at least one type, at the UE, may be a first indication of a first number of simultaneous processing units available for AI enabled CSI computations, AI enabled BM computations, non-AI CSI computations, and non-AI BM computations at the UE, as shown in FIG. 7 at 700. In these embodiments, the method 500 may also include transmitting, via the transceiver, a second indication of a second number of simultaneous processing units available for AI enabled positioning computations at the UE, as shown in FIG. 7 at 704, and transmitting, via the transceiver, a third indication of a processing capability available for non-AI positioning computations at the UE, as shown in FIG. 7 at 702. In these embodiments, the processing units (and typically processing engine(s)) provided for CSI/BM computations are separated from the processing units or resources (and typically processing engine(s)) provided for positioning. Furthermore, the processing units or resources provided for AI enabled positioning computations and non-AI positioning computations are separated. This may be useful, for example, in that UE capabilities for CSI/BM computations may need to be signaled to a network device of a RAN, and UE capabilities for positioning may need to be signaled to an LMF. Furthermore, the complexities of AI enabled positioning computations and non-AI positioning computations may be different, such that few or no resources for non-AI positioning computations may be available, at times, if AI-enabled positioning computations and non-AI positioning computations have to compete for the same processing units or resources. In some embodiments, the number of simultaneous processing units available for AI enabled CSI computations, AI enabled BM computations, non-AI CSI computations, and non-AI BM computations may be managed as already described in technical specifications for managing CPUs available for non-AI CSI computations and non-AI BM computations (possibly with extensions to address AI aspects). In these embodiments, and if UE capability signaling is used for the first indication, the signaling messages shown in FIGS. 4A-4D may be leveraged/reused. In some embodiments, the number of simultaneous processing units available for AI enabled positioning computations may be managed similarly to, but separately from, the number of CPUs available for non-AI CSI computations and non-AI BM computations (possibly with extensions to address positioning aspects).

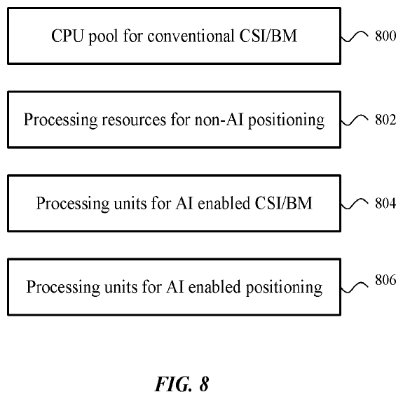

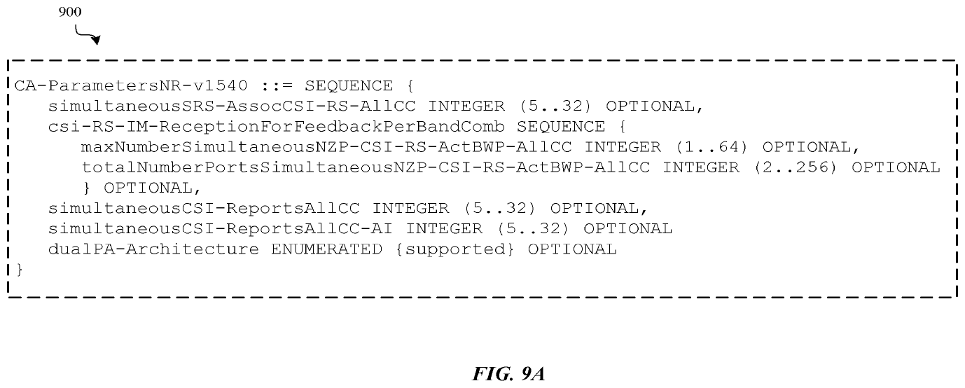

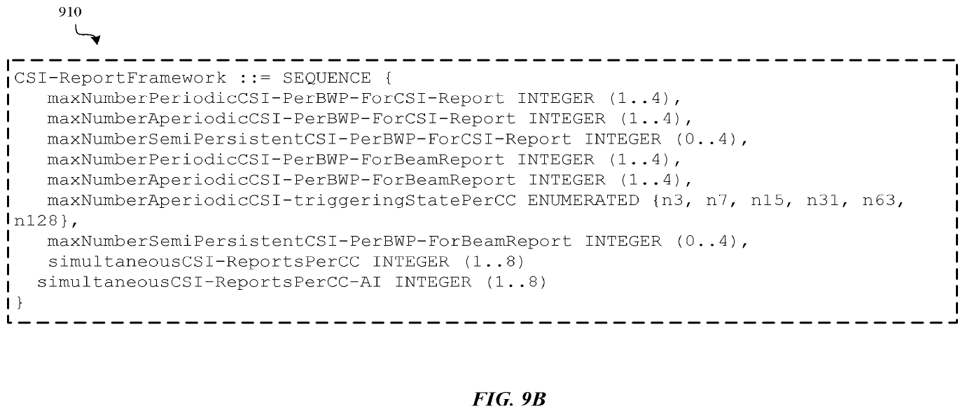

In some embodiments of the method 500, the indication of the number of simultaneous processing units available for AI enabled computations of the at least one type, at the UE, may be a first indication of a first number of simultaneous processing units available for AI enabled CSI computations and AI enabled BM computations at the UE, as shown in FIG. 8 at 804. In these embodiments, the method 500 may also include transmitting, via the transceiver, a second indication of a second number of simultaneous processing units available for AI enabled positioning computations at the UE, as shown in FIG. 8 at 806; transmitting, via the transceiver, a third indication of a third number of simultaneous processing units available for non-AI CSI computations and non-AI BM computations at the UE, as shown in FIG. 8 at 800; and transmitting, via the transceiver, a fourth indication of a processing capability available for non-AI positioning computations at the UE, as shown in FIG. 8 at 802. In these embodiments, the processing units (and typically processing engine(s)) provided for CSI/BM computations are separated from the processing units or resources (and typically processing engine(s)) provided for positioning. Furthermore, the processing units or resources provided for AI enabled computations and non-AI enabled computations are separated (both for CSI/BM computations, and for positioning computations). This may be useful, for example, in that UE capabilities for CSI/BM computations may need to be signaled to a network device of a RAN, and UE capabilities for positioning may need to be signaled to an LMF. Furthermore, the complexities of AI enabled computations and non-AI enabled computations may be different, such that few or no resources for non-AI enabled computations may be available, at times, if AI-enabled computations and non-AI enabled computations have to compete for the same processing units or resources. In some embodiments, the number of simultaneous processing units available for AI enabled CSI computations and AI enabled BM computations may be managed similarly to, but separately from, what is described in technical specifications for managing CPUs available for non-AI CSI computations and non-AI BM computations (possibly with extensions to address AI aspects). In these embodiments, and if UE capability signaling is used for the indications identifying the numbers of processing units at 804 and 806, the signaling messages 900, 910 shown in FIGS. 9A and 9B can be used to indicate the number of processing units for simultaneous AI enabled CSI/BM computations and, separately, the number of processing units for simultaneous non-AI CSI/BM computations. A UE may report with simultaneousCSI-ReportsAllCC-AI for AI CSI/BM computations, to indicate whether the UE supports CSI report framework and the number of CSI report(s) which the UE can simultaneously process across all CCs in a cell group (MCG or SCG, or a specific SCG if multiple SCGs are supported), and across all CCs across cell groups, e.g., MCG and SCG in case of NR-DC. The CSI report may include periodic, semipersistent and aperiodic CSI, and any latency classes and codebook types. The CSI report in simultaneousCSI-ReportsAllCC-AI may include the beam report and CSI report. This parameter may further limit simultaneousCSI-ReportsPerCC-AI in MIMOParametersPerBand and Phy-ParametersFRX-Diff for each band in a given band combination. In some embodiments, the number of simultaneous processing units available for AI enabled positioning computations may also be managed similarly to, but separately from, the number of CPUs available for non-AI CSI computations and non-AI BM computations (possibly with extensions to address positioning aspects).

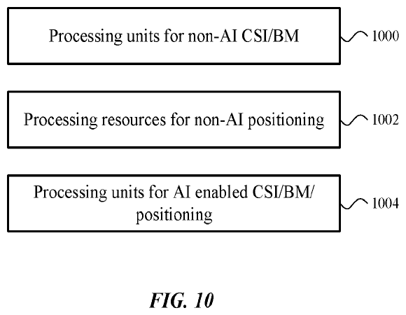

In some embodiments of the method 500, the indication of the number of simultaneous processing units available for AI enabled computations of the at least one type, at the UE, may be a first indication of a first number of simultaneous processing units available for AI enabled CSI computations, AI enabled BM computations, and AI enabled positioning computations at the UE, as shown in FIG. 10 at 1004. In these embodiments, the method 500 may also include transmitting, via the transceiver, a second indication of a second number of simultaneous processing units available for non-AI CSI computations and non-AI BM computations at the UE, as shown in FIG. 10 at 1000; and transmitting, via the transceiver, a third indication of a processing capability available for non-AI positioning computations at the UE, as shown in FIG. 10 at 1002. In these embodiments, the processing units or resources provided for AI enabled computations and non-AI enabled computations are separated, but all AI enabled computations share the same set of processing units. In some embodiments, the number of simultaneous processing units available for AI enabled CSI computations, AI enabled BM computations, and AI enabled positioning computations may be managed similarly to, but separately from, what is described in technical specifications for managing CPUs available for non-AI CSI computations and non-AI BM computations (possibly with extensions to address AI and positioning aspects).

In some embodiments of the method 500, the indication of the number of simultaneous processing units available for AI enabled computations of the at least one type, at the UE, may be a first indication of a first number of simultaneous processing units available for AI enabled CSI computations, AI enabled BM computations, AI enabled positioning computations, non-AI CSI computations, and non-AI BM computations at the UE, as shown in FIG. 11 at 1100. In these embodiments, the method 500 may also include transmitting, via the transceiver, a second indication of a processing capability available for non-AI positioning computations at the UE, as shown in FIG. 11 at 1102. In some embodiments, the processing units for all computations but for non-AI processing computations may be managed as already described in technical specifications for managing CPUs available for non-AI CSI computations and non-AI BM computations (possibly with extensions to address AI and positioning aspects).

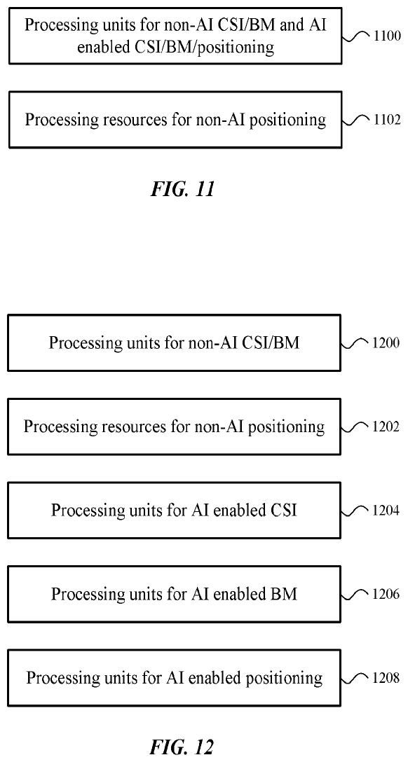

In some embodiments of the method 500, the indication of the number of simultaneous processing units available for AI enabled computations of the at least one type, at the UE, is a first indication of a first number of simultaneous processing units available for AI enabled CSI computations at the UE, as shown in FIG. 12 at 1204. In these embodiments, the method 500 may also include transmitting, via the transceiver, a second indication of a second number of simultaneous processing units available for AI enabled BM computations at the UE, as shown in FIG. 12 at 1206; transmitting, via the transceiver, a third indication of a third number of simultaneous processing units available for AI enabled positioning computations at the UE, as shown in FIG. 12 at 1208; transmitting, via the transceiver, a fourth indication of a fourth number of simultaneous processing units available for non-AI CSI computations and non-AI BM computations at the UE, as shown in FIG. 12 at 1200; and transmitting, via the transceiver, a fifth indication of a processing capability available for non-AI positioning computations at the UE, as shown in FIG. 12 at 1202. In these embodiments, the processing units or resources provided for AI enabled computations and non-AI enabled computations are separated and, among the AI enabled computations, separate sets of processing units are provided for each type of AI enabled computation. In some embodiments, the number of simultaneous processing units available for each type of AI enabled computation may be managed similarly to, but separately from, what is described in technical specifications for managing CPUs available for non-AI CSI computations and non-AI BM computations (possibly with extensions to address AI or positioning aspects).

Although the above paragraphs describe various options for defining the number of simultaneous process units available, at a UE, for one or more types of AI enabled and/or non-AI enabled computations, other options are possible. In some cases, a single pool of simultaneous processing units may be shared among any, some, or all types of AI enabled and non-AI enabled computations.

The indication transmitted at 502, and each of the additional indications referenced in the above embodiments of the method 500, may be associated with one or more conditions. For example, an indicated number of simultaneous processing units may be qualified as being “per CC”, for a particular CC (in which case other indications may be provided for other CCs), or “per UE” (in which case a processing unit that is in use for one CC is not available for use by other CCs).

Although the method 500 is described in terms of transmitting one or more indications of a number of simultaneous processing units and/or a processing capability, one or more of these indications may alternatively be specified in a technical specification or configured by a network device (e.g., a gNB or an LMF).

To determine whether simultaneous AI enabled computations have exceeded an indicated number of simultaneous processing units, the method 500 may include determining a number of simultaneous processing units in use. In some cases, the use of an AI model, or the use of an AI model of a particular type (e.g., transformer vs fully connected network vs convolutional neural network (CNN)), may be associated with a processing unit count. For example, use of one type of AI model to generate an inference may require one processing unit, while use of another type of AI model to generate an inference may require two processing units. Alternatively or additionally, use of one type of AI model to generate an inference may require occupancy of a first number of processing units for a first period of time, while use of another type of AI model to generate an inference may require occupancy of a second number of processing units for a second period of time. The first and second numbers of processing units may be the same or different. Likewise, the first and second periods of time may be the same or different. In some embodiments, information about the number of processing units or periods of time that an AI model requires to generate an inference may be included as part of the metadata of the AI model. In some embodiments, a “processing unit” may be quantified in terms of processing complexity (e.g., number of floating point operations (FLOPS) and/or required amount of memory). In some embodiments, the number of processing units that an AI model, computation, or report requires may be defined in terms of a type of feedback (e.g., CSI, BM, or positioning); a number of FLOPS; and/or one or more of other parameters (e.g., a memory requirement). In some embodiments, the number of processing units that an AI model, computation, or report requires may be defined in terms of a multiple of a CPU unit used for non-AI (e.g., legacy) CSI/BM computation/reporting.

In some embodiments of the method 500, the number of processing units required to perform different AI enabled functions may differ. For example, a CSI computation may require a different number of processing units compared to a BM computation. As another example, a CSI prediction function may require a different number of processing units compared to a CSI compression function. Of course, different AI enabled functions may also require the same number of processing units. Corresponding AI enabled functions and non-AI functions may also require the same or different numbers of processing units. Different functions, whether AI enabled or not, may also use different AI models.

In some cases, the number of processing units required by a particular function may be reflected in a report transmitted by the UE. For example, if a CSI report requires an inference to be made using AI model 1, which is associated with X processing units, then generating the CSI report consumes X processing units (which may or may not be reflected in the CSI report, or may be indicated as a UE capability or in other ways).

In NR Rel-18 and earlier 3GPP releases, CSI/BM computations and positioning computations (i.e., non-AI CSI/BM computations and non-AI positioning computations) use different processing resources, and CPU occupancy rules are only defined for non-AI CSI/BM computations. Prioritization rules are also defined for non-AI CSI/BM computations (or reporting). Prioritization rules determine what CSI reports are generated with fresh feedback when CSI/BM computations are limited by CPU occupancy rules or other factors. In the above-described embodiments of method 500 that separate the number of simultaneous processing units available for CSI and/or BM computations from the number of simultaneous processing units (or processing resources) available for positioning computations (regardless of whether the computations are AI enabled computations or non-AI computations, the Rel-18 prioritization rules may be used for CSI/BM computations (or reporting). However, and as dictated by the various embodiments, separate numbers of simultaneous processing units may be tracked. In the above-described embodiments of method 500 that share a number of simultaneous processing units between positioning computations and one or both of CSI computations or BM computations, new prioritization rules may be needed (e.g., according to the report quantity, PRS reporting, etc.) and may be expanded from 3GPP TS 38.214 formulas, for example. For example, the CSI prioritization rules provided in 3GPP TS 38.214 may be expanded to define new values of y, k, Mₛ when a number of simultaneous processing units available for computations is shared by positioning computations and one or both of CSI computations or BM computations.

In accordance with NR Rel-16 positioning, a PRS measurement is only expected to be performed by a UE within a measurement gap (MG)—i.e., when CSI/BM measurements are not being performed. However, in accordance with NR Rel-17 positioning, a UE that is capable of PRS measurement outside of a MG may make a PRS measurement within an active bandwidth part (BWP) or within a MG. NR Rel-17 therefore defines different UE capabilities and prioritization rules that define whether/how a UE may simultaneously receive a PRS and other DL signals/channels. In a context that is similar to the context described in NR Rel-17 positioning, a UE that tracks a number of simultaneous processing units used by positioning computations and one or both of CSI computations or BM computations may be presented with scenarios in which the UE may perform positioning computations and one or both of CSI computations or BM computations simultaneously. Prioritization rules that define whether/how a UE may simultaneously perform positioning computations and one or both of CSI computations or BM computations may therefore be needed.

In some embodiments of the method 500, the AI enabled computations of the at least one type, referenced at 502 and 504, may include AI enabled CSI computations, AI enabled BM computations, and AI enabled positioning computations. In these embodiments, various prioritization rules may be applied. For example, in some cases, the method 500 may include prioritizing AI enabled BM computations (or reporting) over AI enabled CSI computations (or reporting), and prioritizing AI enabled CSI computations (or reporting) over AI enabled positioning computations (or reporting) (e.g., BM>CSI>positioning). In some cases, the method 500 may include prioritizing AI enabled CSI computations (or reporting) and AI enabled BM computations (or reporting) in accordance with one or more prioritization rules (e.g., as currently described in NR Rel-17), and prioritizing AI enabled CSI computations (or reporting) and AI enabled BM computations (or reporting) over AI enabled positioning computations (or reporting). In some cases, the method 500 may include receiving, via the transceiver, an indication of one or more prioritization rules for AI enabled CSI computations (or reporting), AI enabled BM computations (or reporting), and AI enabled positioning computations (or reporting), and prioritizing AI enabled CSI computations (or reporting), AI enabled BM computations (or reporting), and AI enabled positioning computations (or reporting) in accordance with the one or more prioritization rules. In the latter cases, the one or more prioritization rules may be received via=RRC signaling and/or a medium access control (MAC) control element (MAC CE), and may be configured for various use cases and sub-use cases as configured by the network.

When one or more prioritization rules are signaled by the network (e.g., through RRC signaling and/or a MAC CE), the network may indicate that AI enabled positioning computations (or reporting) are higher priority than AI enabled CSI computations (or reporting) or AI enabled BM computations (or reporting) in certain use cases—e.g., in use cases where robots are equipped with NR radios and their positioning may be critical to their performance of their missions.

In some embodiments, the RRC signaling of one or more prioritization rules may include (or consist of) a selection of a prioritization pattern in a set of multiple prioritization patterns known to the UE and the network (e.g., an index into a set of multiple prioritization patterns that are predefined by a specification or configured by the network).

In some embodiments, the one or more prioritization rules may be signaled (e.g., in RRC signaling) per report requested by the network. For example, when a UE is involved in multiple traffic flows (e.g., transmission and/or reception traffic flows), such as in an extended reality (XR) scenario, a successful transmission/reception on a particular traffic flow may require the transmission of a minimum set of reports, from the UE to the network (e.g., one report for BM for CC1, one report for CSI for CC1 with 2 transmit (Tx) ports, and one report for positioning). In parallel with the previously described traffic flow, the UE may be engaged in other traffic flows (e.g., traffic flows involving CC1 with 32 Tx ports, on CC2, on CC3, etc.). To ensure that important traffic flows get preferential treatment from the UE reporting point of view, a list of reports configured by the network may be maintained by both the network and the UE. Similar to a list utilized in a computer programming language (or programming language), reports may be inserted into or deleted from the list. A global index across use cases may also be used to prioritize each CSI/BM/positioning report. An example list is shown below:

```
CSI report 1 {
  Global_index <--3,
  ...
  }
CSI report 2 {
  Global_index <--4,
  ...
  }
BM report 3 {
  Global_index <--8,
  }
Positioning report 5 {
  Global index <--11
  }
```

In the above list, {3, 4, 8, 11} signifies the prioritization order of CSI report 1>CSI report 2>BM report 3>positioning report 5. The list could alternatively be signaled as {3, 8, 11, 4} to signify the prioritization order of CSI report 1>BM report 3>positioning report 5>CSI report 2.

Although the above prioritization rules are described primarily with reference to AI enabled computations (or reporting), the above prioritization rules may also be applied to non-AI computations (or reporting) or combinations of AI-enabled computations (or reporting) and non-AI computations (or reporting).

In the existing NR Rel-17 CSI/BM feedback design, and for aperiodic CSI reporting, the CPUs required to generate a CSI report are considered “occupied” from the end of a PDCCH carrying the trigger signaling for aperiodic CSI/BM reporting, until the end of the PUSCH transmission that carries the uplink control information (UCI) which contains the CSI report. As previously described with reference to FIG. 3, two processing time requirements that need to be met before a CSI report can be expected to be transmitted to a network are Z and Z′. For AI enabled computations (or reporting), values for Z and Z′ may be introduced for each use case (e.g., for CSI, for BM, and for positioning) or even each sub-use case (e.g., for BM using a CNN, for BM with 16 beams in a Set B, for CSI with 32 ports, for CSI with prediction, for CSI with compression, etc.).

In some embodiments, the method 500 may include transmitting, via the transceiver, an indication of processing time requirements (e.g., Z and Z′) for a type of AI enabled computation. For example, the UE may transmit a Z/Z′ table for CSI feedback below 16 Tx ports and 13 subbands. With CSI generalization, a single AI model (or engine) may need to run multiple times to cover 32 Tx ports and 26 subbands, to account for the processing load. In one option, 2×2=4 processing units may be occupied, which assumes a tradeoff is allowed between CSI processing time and CSI processing power. This may not be valid for every UE implementation. In another option, Z and/or Z′ may be increased (e.g., by 4 times), which again assumes a tradeoff is allowed between CSI processing time and CSI processing power. And again, this may not be valid for every UE implementation. Some processing time requirements may need to be reported to a RAN (e.g., to a gNB, for CSI/BM processing), and some processing time requirements may need to be reported to a CN (e.g., to an LMF, for positioning processing).

Alternatively, minimum processing time requirements may be defined in a technical specification. In some embodiments, the scheme used to provide processing resources for conventional positioning may be used for AI enabled positioning (e.g., as specified in 3GPP TS 38.214, § 5.1.6.5 for PRS reception).

In another option, multiple tables of processing time requirements (e.g., tables of Z/Z′) may be standardized (e.g., according to UE capabilities). For example, a first table may be provided for very fast AI inferences, a second table may be provided for moderately fast AI inferences, and a third table may be provided for energy-saving (and slower) AI inferences. In such a case, a UE may transmit an indication of a number of simultaneous processing units required, by the UE, to meet a set of processing time requirements defined by a particular table. For example, the UE could provide one or more indications as follows:
{10 processing units for table 1, 8 processing units for table 2, 4 processing units for table 3}
{12 processing units for table 1}
{30 processing units for table 2}

As previously mentioned, processing time requirements may be indicated per CC, over all CCs in a cell group, over all CCs across all cell groups, for CCs in a band, or for CCs in a band in a band combination.

The above indications are alternatives. For example, the UE may be able to provide a combination of processing units for tables 1, 2, and 3; or 12 processing units for table 1; or 30 processing units for table 2. With multiple profiles for fast/moderate/slower speed AI feedback, the network can choose the most suitable profile to use. In some embodiments, a UE may be able to deduce which profile the network is using. In some embodiments, the network may indicate which profile the network is using. The latter may ensure that the UE is able to properly configures its hardware and firmware.

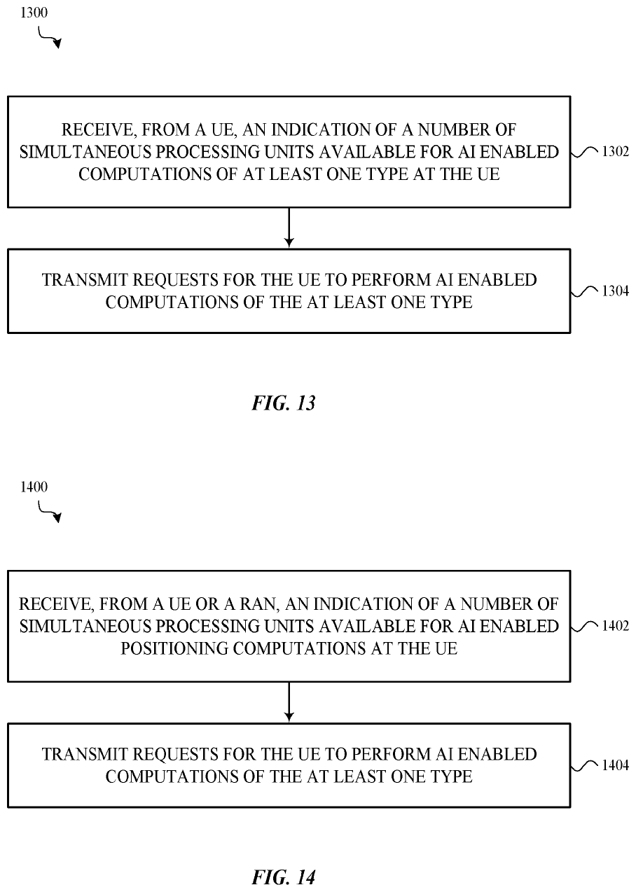

FIG. 13 shows an example method 1300 of wireless communication by a network device (e.g., a network device of a RAN). In some cases, the network device may be the gNB described with reference to FIG. 1 or one of the other network devices described herein. The method 1300 may be performed using a processor, a main radio (or transceiver), or other components of the network device.

At 1302, the method 1300 may include receiving, via the transceiver and from a UE, an indication of a number of simultaneous processing units available for AI enabled computations of at least one type at the UE. In some embodiments, the number of simultaneous processing units available for AI enabled computations of the at least one type may also be available to at least one type of non-AI computation.

At 1304, the method 1300 may include transmitting, via the transceiver, requests for the UE to perform AI enabled computations of the at least one type.

The method 1300 may be variously embodied, extended, or adapted, as described with reference to FIG. 5 and elsewhere in this description.

FIG. 14 shows an example method 1400 of wireless communication by a network device (e.g., a network device of a CN). In some cases, the network device may be the LMF described with reference to FIG. 1 or one of the other network devices described herein. The method 1400 may be performed using a processor, a communications interface, or other components of the network device.

At 1402, the method 1400 may include receiving, via the communications interface and from a UE or a RAN, an indication of a number of simultaneous processing units available for AI enabled positioning computations at the UE. In some embodiments, the number of simultaneous processing units available for AI enabled positioning computations may also be available to at least one type of non-AI computation.

At 1404, the method 1400 may include transmitting, via the communications interface, requests for the UE to perform AI enabled positioning computations.

The method 1400 may be variously embodied, extended, or adapted, as described with reference to FIG. 5 and elsewhere in this description.

Embodiments contemplated herein include one or more non-transitory computer-readable media storing instructions to cause an electronic device, upon execution of the instructions by one or more processors of the electronic device, to perform one or more elements of the method 500, 1300, or 1400. In the context of method 500, this non-transitory computer-readable media may be, for example, a memory of a UE (such as a memory 1606 of a wireless device 1602 that is a UE, as described herein). In the context of method 1300 or 1400, this non-transitory computer-readable media may be, for example, a memory of a network device (such as a memory 1624 of a network device 1620, as described herein).

Embodiments contemplated herein include an apparatus having logic, modules, or circuitry to perform one or more elements of the method 500, 1300, or 1400. In the context of method 500, this apparatus may be, for example, an apparatus of a UE (such as a wireless device 1602 that is a UE, as described herein). In the context of method 1300 or 1400, this apparatus may be, for example, an apparatus of a network device (such as a network device 1620, as described herein).

Embodiments contemplated herein include an apparatus having one or more processors and one or more computer-readable media, using or storing instructions that, when executed by the one or more processors, cause the one or more processors to perform one or more elements of the method 500, 1300, or 1400. In the context of method 500, this apparatus may be, for example, an apparatus of a UE (such as a wireless device 1602 that is a UE, as described herein). In the context of the method 1300 or 1400, this apparatus may be, for example, an apparatus of a network device (such as a network device 1620, as described herein).

Embodiments contemplated herein include a signal as described in or related to one or more elements of the method 500, 1300, or 1400.

Embodiments contemplated herein include a computer program or computer program product having instructions, wherein execution of the program by a processor causes the processor to carry out one or more elements of the method 500, 1300, or 1400. In the context of method 500, the processor may be a processor of a UE (such as a processor(s) 1604 of a wireless device 1602 that is a UE, as described herein), and the instructions may be, for example, located in the processor and/or on a memory of the UE (such as a memory 1606 of a wireless device 1602 that is a UE, as described herein). In the context of method 1300 or 1400, the processor may be a processor of a network device (such as a processor(s) 1622 of a network device 1620, as described herein), and the instructions may be, for example, located in the processor and/or on a memory of the network device (such as a memory 1624 of a network device 1620, as described herein).

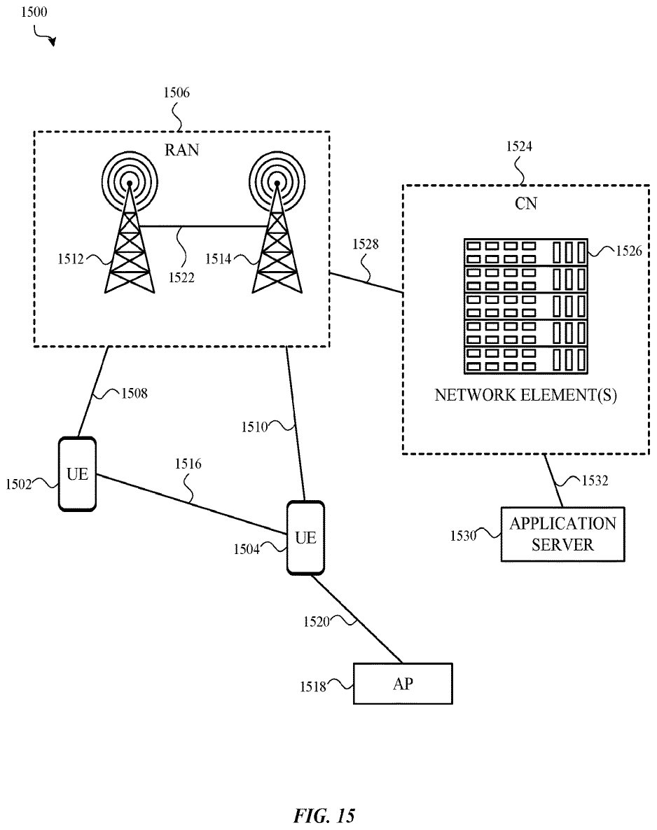

FIG. 15 illustrates an example architecture of a wireless communication system, according to embodiments described herein. The following description is provided for an example wireless communication system 1500 that operates in conjunction with the LTE system standards or specifications and/or 5G or NR system standards or specifications, as provided by 3GPP technical specifications.

As shown by FIG. 15, the wireless communication system 1500 includes UE 1502 and UE 1504 (although any number of UEs may be used). In this example, the UE 1502 and the UE 1504 are illustrated as smartphones (e.g., handheld touchscreen mobile computing devices connectable to one or more cellular networks), but may also comprise any mobile or non-mobile computing device configured for wireless communication.

The UE 1502 and UE 1504 may be configured to communicatively couple with a RAN 1506. In embodiments, the RAN 1506 may be NG-RAN, E-UTRAN, etc. The UE 1502 and UE 1504 utilize connections (or channels) (shown as connection 1508 and connection 1510, respectively) with the RAN 1506, each of which comprises a physical communications interface. The RAN 1506 can include one or more network devices, such as base station 1512 and base station 1514, that enable the connection 1508 and connection 1510.

In this example, the connection 1508 and connection 1510 are air interfaces to enable such communicative coupling, and may be consistent with RAT(s) used by the RAN 1506, such as, for example, an LTE and/or NR.

In some embodiments, the UE 1502 and UE 1504 may also directly exchange communication data via a sidelink interface 1516. The UE 1504 is shown to be configured to access an access point (shown as AP 1518) via connection 1520. By way of example, the connection 1520 can comprise a local wireless connection, such as a connection consistent with any IEEE 802.11 protocol, wherein the AP 1518 may comprise a Wi-Fi® router. In this example, the AP 1518 may be connected to another network (for example, the Internet) without going through a CN 1524.

In embodiments, the UE 1502 and UE 1504 can be configured to communicate using orthogonal frequency division multiplexing (OFDM) communication signals with each other or with the base station 1512 and/or the base station 1514 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1512 or base station 1514 may be implemented as one or more software entities running on server computers as part of a virtual network. In addition, or in other embodiments, the base station 1512 or base station 1514 may be configured to communicate with one another via interface 1522. In embodiments where the wireless communication system 1500 is an LTE system (e.g., when the CN 1524 is an EPC), the interface 1522 may be an X2 interface. The X2 interface may be defined between two or more network devices of a RAN (e.g., two or more eNBs and the like) that connect to an EPC, and/or between two eNBs connecting to the EPC. In embodiments where the wireless communication system 1500 is an NR system (e.g., when CN 1524 is a 5GC), the interface 1522 may be an Xn interface. The Xn interface is defined between two or more network devices of a RAN (e.g., two or more gNBs and the like) that connect to the 5GC, between a base station 1512 (e.g., a gNB) connecting to the 5GC and an eNB, and/or between two eNBs connecting to the 5GC (e.g., CN 1524).

The RAN 1506 is shown to be communicatively coupled to the CN 1524. The CN 1524 may comprise one or more network elements 1526, which are configured to offer various data and telecommunications services to customers/subscribers (e.g., users of UE 1502 and UE 1504) who are connected to the CN 1524 via the RAN 1506. The components of the CN 1524 may be implemented in one physical device or separate physical devices including components to read and execute instructions from a machine-readable or computer-readable medium (e.g., a non-transitory machine-readable storage medium).

In embodiments, the CN 1524 may be an EPC, and the RAN 1506 may be connected with the CN 1524 via an S1 interface 1528. In embodiments, the S1 interface 1528 may be split into two parts, an S1 user plane (S1-U) interface, which carries traffic data between the base station 1512 or base station 1514 and a serving gateway (S-GW), and the S1-MME interface, which is a signaling interface between the base station 1512 or base station 1514 and mobility management entities (MMEs).

In embodiments, the CN 1524 may be a 5GC, and the RAN 1506 may be connected with the CN 1524 via an NG interface 1528. In embodiments, the NG interface 1528 may be split into two parts, an NG user plane (NG-U) interface, which carries traffic data between the base station 1512 or base station 1514 and a user plane function (UPF), and the S1 control plane (NG-C) interface, which is a signaling interface between the base station 1512 or base station 1514 and access and mobility management functions (AMFs). A signaling interface (NLs) may be provided between an AMF and an LMF of the CN 1524.

Generally, an application server 1530 may be an element offering applications that use internet protocol (IP) bearer resources with the CN 1524 (e.g., packet switched data services). The application server 1530 can also be configured to support one or more communication services (e.g., VoIP sessions, group communication sessions, etc.) for the UE 1502 and UE 1504 via the CN 1524. The application server 1530 may communicate with the CN 1524 through an IP communications interface 1532.

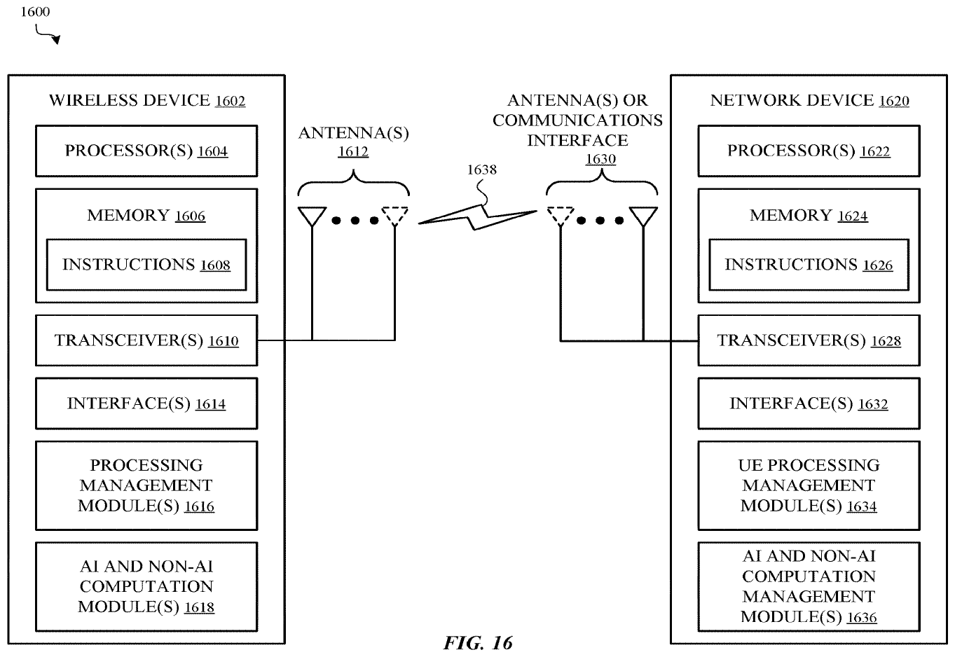

FIG. 16 illustrates an example system 1600 for performing signaling 1638 between a wireless device 1602 and a network device 1620, according to embodiments described herein. The system 1600 may be a portion of a wireless communication system as herein described. The wireless device 1602 may be, for example, a UE of a wireless communication system. The network device 1620 may be, for example, a network device of a RAN (e.g., an eNB or a gNB) or a radio head of a wireless communication system. Alternatively, the network device 1620 may be, for example, an LMF of a CN (in which communications between the wireless device 1602 and the network device 1620 may travel through other network devices instead of traveling directly between the wireless device 1602 and the network device 1620, over wireless and/or wired connections).

The wireless device 1602 may include one or more processor(s) 1604. The processor(s) 1604 may execute instructions such that various operations of the wireless device 1602 are performed, as described herein. The processor(s) 1604 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1602 may include a memory 1606. The memory 1606 may be a non-transitory computer-readable storage medium that stores instructions 1608 (which may include, for example, the instructions being executed by the processor(s) 1604). The instructions 1608 may also be referred to as program code or a computer program. The memory 1606 may also store data used by, and results computed by, the processor(s) 1604.

The wireless device 1602 may include one or more transceiver(s) 1610 (also collectively referred to as a transceiver 1610) that may include radio frequency (RF) transmitter and/or receiver circuitry that use the antenna(s) 1612 of the wireless device 1602 to facilitate signaling (e.g., the signaling 1638) to and/or from the wireless device 1602 with other devices (e.g., the network device 1620) according to corresponding RATs.

The wireless device 1602 may include one or more antenna(s) 1612 (e.g., one, two, four, eight, or more). For embodiments with multiple antenna(s) 1612, the wireless device 1602 may leverage the spatial diversity of such multiple antenna(s) 1612 to send and/or receive multiple different data streams on the same time and frequency resources. This behavior may be referred to as, for example, MIMO behavior (referring to the multiple antennas used at each of a transmitting device and a receiving device that enable this aspect). MIMO transmissions by the wireless device 1602 may be accomplished according to precoding (or digital beamforming) that is applied at the wireless device 1602 that multiplexes the data streams across the antenna(s) 1612 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 1602 may implement analog beamforming techniques, whereby phases of the signals sent by the antenna(s) 1612 are relatively adjusted such that the (joint) transmission of the antenna(s) 1612 can be directed (this is sometimes referred to as beam steering).

The wireless device 1602 may include one or more interface(s) 1614. The interface(s) 1614 may be used to provide input to or output from the wireless device 1602. For example, a wireless device 1602 that is a UE may include interface(s) 1614 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1610/antenna(s) 1612 already described) that allow for communication between the UE and other devices and may operate according to known protocols (e.g., Wi-Fi®, Bluetooth®, and the like).

The wireless device 1602 may include processing management module(s) 1616 and AI and non-AI computation module(s) 1618. The processing management module(s) 1616 and AI and non-AI computation module(s) 1618 may be implemented via hardware, software, or combinations thereof. For example, the processing management module(s) 1616 and AI and non-AI computation module(s) 1618 may be implemented as a processor, circuit, and/or instructions 1608 stored in the memory 1606 and executed by the processor(s) 1604. In some examples, the processing management module(s) 1616 and AI and non-AI computation module(s) 1618 may be integrated within the processor(s) 1604 and/or the transceiver(s) 1610. For example, the processing management module(s) 1616 and AI and non-AI computation module(s) 1618 may be implemented by a combination of software components (e.g., executed by a DSP or a general processor) and hardware components (e.g., logic gates and circuitry) within the processor(s) 1604 or the transceiver(s) 1610.

The processing management module(s) 1616 and AI and non-AI computation module(s) 1618 may be used for various aspects of the present disclosure, for example, aspects of FIGS. 1-14, from a wireless device or UE perspective. The processing management module(s) 1616 may be configured to, for example, manage and report capabilities pertaining to required processing units, processing times, and other parameters related to AI and non-AI computations (or reporting). The AI and non-AI computation module(s) 1618 may be configured to, for example, perform AI and non-AI computations in accordance with the parameters managed by the processing management module(s) 1616.

The network device 1620 may include one or more processor(s) 1622. The processor(s) 1622 may execute instructions such that various operations of the network device 1620 are performed, as described herein. The processor(s) 1622 may include one or more baseband processors implemented using, for example, a CPU, a DSP, an ASIC, a controller, an FPGA device, another hardware device, a firmware device, or any combination thereof configured to perform the operations described herein.

The network device 1620 may include a memory 1624. The memory 1624 may be a non-transitory computer-readable storage medium that stores instructions 1626 (which may include, for example, the instructions being executed by the processor(s) 1622). The instructions 1626 may also be referred to as program code or a computer program. The memory 1624 may also store data used by, and results computed by, the processor(s) 1622.

The network device 1620 may include one or more transceiver(s) 1628 (also collectively referred to as a transceiver 1628) that may include RF transmitter and/or receiver circuitry that use the antenna(s) 1630 of the network device 1620 to facilitate signaling (e.g., the signaling 1638) to and/or from the network device 1620 with other devices (e.g., the wireless device 1602) according to corresponding RATs.

The network device 1620 may include one or more antenna(s) 1630 (e.g., one, two, four, or more). In embodiments having multiple antenna(s) 1630, the network device 1620 may perform MIMO, digital beamforming, analog beamforming, beam steering, etc., as has been described.

The network device 1620 may include one or more interface(s) 1632. The interface(s) 1632 may be used to provide input to or output from the network device 1620. For example, a network device 1620 of a RAN (e.g., a base station, a radio head, etc.) may include interface(s) 1632 made up of transmitters, receivers, and other circuitry (e.g., other than the transceiver(s) 1628/antenna(s) 1630 already described) that enables the network device 1620 to communicate with other equipment in a network, and/or that enables the network device 1620 to communicate with external networks, computers, databases, and the like for purposes of operations, administration, and maintenance of the network device 1620 or other equipment operably connected thereto.

The network device 1620 may include one or more UE processing management module(s) 1634 and AI and non-AI computation management module(s) 1636. The UE processing management module(s) 1634 and AI and non-AI computation management module(s) 1636 may be implemented via hardware, software, or combinations thereof. For example, the UE processing management module(s) 1634 and AI and non-AI computation management module(s) 1636 may be implemented as a processor, circuit, and/or instructions 1626 stored in the memory 1624 and executed by the processor(s) 1622. In some examples, the UE processing management module(s) 1634 and AI and non-AI computation management module(s) 1636 may be integrated within the processor(s) 1622 and/or the transceiver(s) 1628. For example, the UE processing management module(s) 1634 and AI and non-AI computation management module(s) 1636 may be implemented by a combination of software components (e.g., executed by a DSP or a general processor) and hardware components (e.g., logic gates and circuitry) within the processor(s) 1622 or the transceiver(s) 1628.

The UE processing management module(s) 1634 and AI and non-AI computation management module(s) 1636 may be used for various aspects of the present disclosure, for example, aspects of FIGS. 1-14, from a network device perspective. The UE processing management module(s) 1634 may be configured to, for example, receive reported UE capabilities pertaining to required processing units, processing times, and other parameters related to AI and non-AI computations (or reporting) by a wireless device (e.g., the wireless device 1602). The AI and non-AI computation module(s) 1636 may be configured to, for example, request AI and non-AI computations in accordance with the parameters managed by the UE processing management module(s) 1634.

For one or more embodiments, at least one of the components set forth in one or more of the preceding figures may be configured to perform one or more operations, techniques, processes, and/or methods as set forth herein. For example, a baseband processor (or processor) as described herein in connection with one or more of the preceding figures may be configured to operate in accordance with one or more of the examples set forth herein. For another example, circuitry associated with a UE, network device, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form described. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

The systems described herein pertain to specific embodiments but are provided as examples. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. An apparatus comprising memory coupled to a processor, the processor configured to:
generate, for transmission, an indication of a number of simultaneous processing units available for artificial intelligence (AI) enabled computations of at least one type at the UE; and
deny or delay simultaneous AI enabled computations that exceed the number of simultaneous processing units available for AI enabled computations of the at least one type at the UE.

2. The apparatus of claim 1, wherein:
the number of simultaneous processing units available for AI enabled computations of the at least one type is also available to at least one type of non-AI computation; and
the processor is configured to deny or delay AI enabled computations, non-AI computations, or a combination of AI enabled computations and non-AI computations that exceed the number of simultaneous processing units available for AI enabled computations of the at least one type at the UE.

3. The apparatus of claim 1, wherein:
the indication of the number of simultaneous processing units available for AI enabled computations of the at least one type, at the UE, is a first indication of a first number of simultaneous processing units available for AI enabled channel state information (CSI) computations, AI enabled beam management (BM) computations, non-AI CSI computations, and non-AI BM computations at the UE; and
the processor is configured to generate, for transmission, a second indication of a second number of simultaneous processing units available for AI enabled positioning computations and non-AI positioning computations at the UE.

4. The apparatus of claim 1, wherein:
the indication of the number of simultaneous processing units available for AI enabled computations of the at least one type, at the UE, is a first indication of a first number of simultaneous processing units available for AI enabled channel state information (CSI) computations, AI enabled beam management (BM) computations, non-AI CSI computations, and non-AI BM computations at the UE; and
the processor is configured to:
generate, for transmission, a second indication of a second number of simultaneous processing units available for AI enabled positioning computations at the UE; and
generate, for transmission, a third indication of a processing capability available for non-AI positioning computations at the UE.

5. The apparatus of claim 1, wherein:
the indication of the number of simultaneous processing units available for AI enabled computations of the at least one type, at the UE, is a first indication of a first number of simultaneous processing units available for AI enabled channel state information (CSI) computations and AI enabled beam management (BM) computations at the UE; and
the processor is configured to:
generate, for transmission, a second indication of a second number of simultaneous processing units available for AI enabled positioning computations at the UE;
generate, for transmission, a third indication of a third number of simultaneous processing units available for non-AI CSI computations and non-AI BM computations at the UE; and
generate, for transmission, a fourth indication of a processing capability available for non-AI positioning computations at the UE.

6. The apparatus of claim 1, wherein:
the indication of the number of simultaneous processing units available for AI enabled computations of the at least one type at the UE is a first indication of a first number of simultaneous processing units available for AI enabled channel state information (CSI) computations, AI enabled beam management (BM) computations, and AI enabled positioning computations at the UE; and
the processor is configured to:
generate, for transmission, a second indication of a second number of simultaneous processing units available for non-AI CSI computations and non-AI BM computations at the UE; and
generate, for transmission, a third indication of a processing capability available for non-AI positioning computations at the UE.

7. The apparatus of claim 1, wherein:
the indication of the number of simultaneous processing units available for AI enabled computations of the at least one type at the UE is a first indication of a first number of simultaneous processing units available for AI enabled channel state information (CSI) computations, AI enabled beam management (BM) computations, AI enabled positioning computations, non-AI CSI computations, and non-AI BM computations at the UE; and
the processor is configured to generate, for transmission, a second indication of a processing capability available for non-AI positioning computations at the UE.

8. The apparatus of claim 1, wherein:
the indication of the number of simultaneous processing units available for AI enabled computations of the at least one type at the UE is a first indication of a first number of simultaneous processing units available for AI enabled channel state information (CSI) computations at the UE; and
the processor is configured to:
generate, for transmission, a second indication of a second number of simultaneous processing units available for AI enabled beam management (BM) computations at the UE;
generate, for transmission, a third indication of a third number of simultaneous processing units available for AI enabled positioning computations at the UE;
generate, for transmission, a fourth indication of a fourth number of simultaneous processing units available for non-AI CSI computations and non-AI BM computations at the UE; and
generate, for transmission, a fifth indication of a processing capability available for non-AI positioning computations at the UE.

9. The apparatus of claim 1, wherein the indication of the number of simultaneous processing units available for AI enabled computations of the at least one type, at the UE, is provided per component carrier (CC).

10. The apparatus of claim 1, wherein the indication of the number of simultaneous processing units available for AI enabled computations of the at least one type, at the UE, is provided for all component carriers (CCs) of the UE.

11. The apparatus of claim 1, wherein:
the AI enabled computations of the at least one type include AI enabled channel state information (CSI) computations, AI enabled beam management (BM) computations, and AI enabled positioning computations at the UE; and
the processor is configured to:
prioritize AI enabled BM computations over AI enabled CSI computations; and
prioritize AI enabled CSI computations over AI enabled positioning computations.

12. The apparatus of claim 1, wherein:
the AI enabled computations of the at least one type include AI enabled channel state information (CSI) computations, AI enabled beam management (BM) computations, and AI enabled positioning computations at the UE; and
the processor is configured to:
prioritize AI enabled CSI computations and AI enabled BM computations in accordance with one or more prioritization rules; and
prioritize AI enabled CSI computations and AI enabled BM computations over AI enabled positioning computations.

13. The apparatus of claim 1, wherein:
the AI enabled computations of the at least one type include AI enabled channel state information (CSI) computations, AI enabled beam management (BM) computations, and AI enabled positioning computations at the UE; and
the processor is configured to:
receive an indication of one or more prioritization rules for AI enabled CSI computations, AI enabled BM computations, and AI enabled positioning computations; and
prioritize AI enabled CSI computations, AI enabled BM computations, and AI enabled positioning computations in accordance with the one or more prioritization rules.

14. The apparatus of claim 13, wherein the indication of the one or more prioritization rules is received as a selection of a prioritization pattern.

15. The apparatus of claim 13, wherein the indication of the one or more prioritization rules is received as a list.

16. The apparatus of claim 1, wherein the processor is configured to generate, for transmission, an indication of processing time requirements for a type of AI enabled computation.

17. The apparatus of claim 1, wherein the processor is configured to generate, for transmission, an indication of a number of simultaneous processing units required, by the UE, to meet a set of processing time requirements.

18. An apparatus comprising memory coupled to a processor, the processor configured to:
receive, from a user equipment (UE), an indication of a number of simultaneous processing units available for artificial intelligence (AI) enabled computations of at least one type at the UE; and
generate, for transmission, requests for the UE to perform AI enabled computations of the at least one type.

19. The apparatus of claim 18, wherein the number of simultaneous processing units available for AI enabled computations of the at least one type is also available to at least one type of non-AI computation.

20. An apparatus comprising memory coupled to a processor, the processor configured to:
receive, via a communications interface and from a user equipment (UE) or a radio access network (RAN), an indication of a number of simultaneous processing units available for artificial intelligence (AI) enabled positioning computations at the UE; and
generate, for transmission via the communications interface, requests for the UE to perform AI enabled positioning computations.
